(19) United States
(12) Patent Application Publication
(10) Pub. No.: US 2009/0320675 A1
(43) Pub. Date: Dec. 31, 2009

(54) Mosaic Transparent Armor

(76) Inventors: Richard L. Landingham, Livermore, CA (US); Steve J. DeTeresa, Oakton, VA (US); John Hunter, Poway, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(21) Appl. No.: 12/107,277

(22) Filed: Apr. 22, 2008

Related U.S. Application Data
(60) Provisional application No. 60/925,915, filed on Apr. 23, 2007.

(51) Int. Cl. F41H 5/04; B32B 7/12; B32B 3/10

(52) U.S. Cl. 89/36.02; 428/46; 428/195.1

(57) ABSTRACT

A damage localizing transparent armor having one or more mosaic tile layers each having two or more transparent projectile-resistant tiles bonded together along their edges in a mosaic arrangement, and preferably a transparent polymer backing plate bonded to a face of the mosaic tile layer with a transparent adhesive, to form a transparent protective panel capable of providing see-through shielding against small arms projectiles and shards from explosive devices. The edge-bonded mosaic arrangement of the mosaic tile layer reduces the energy transferred from an impacted tile to an adjacent tile of the mosaic tile layer, so as to localize damage caused by these projectiles, and increase the multi-hit capability of the transparent armor.

### CROSS-REFERENCE TO RELATED APPLICATIONS

This application claims the benefit of U.S. Provisional Application No. 60/925,915, filed Apr. 23, 2007, entitled “Mosaic Transparent Armor” by Richard L. Landingham et al, incorporated by reference herein.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to transparent armor structures, and more particularly to mosaic transparent armor, shields, panels, and broad-area partitions constructed from mosaically arranged and edge-bonded transparent tiles which localize and limit the damage sustained in one tile, such as from ballistic impact, from also damaging laterally adjacent tiles.

### BACKGROUND OF THE INVENTION

Transparent armor, also commonly known as bulletproof or bullet-resistant “glass,” is commonly used in vehicles, aircraft, and fixed sites (e.g. windows in buildings) by military and law enforcement agencies, commercial and private security organizations, and other public and private interests, for shielding people and cargo from small arms fire, shards from explosive devices, and other types of projectiles and debris, while having the appearance and light-transmitting behavior of standard window glass. Transparent armor can be constructed using thick glass or other hard transparent material which imparts resistance to penetration when struck by bullets, shards, and debris. Current state-of-the-art transparent armor, however, is made almost exclusively from thin bonded layers of window glass, due to their low cost. Polymer layers (e.g. polycarbonate, urethane, etc.) are also commonly used together with glass, either sandwiched between these thin laminated glass layers, or used as backing for these glass layers.

One problem with common window glass used as armor material is its poor multi-hit ballistic performance capability, In particular, because of the brittle nature of glass, a single ballistic impact can fracture and weaken a substantially larger area than the point of impact. This can severely impair visibility through the window, and also potentially lead to catastrophic failure from subsequent impacts. The multi-hit ballistic performance of glass can be improved however using laminated glass constructed from multiple glass sheets bonded together with, for example, polyvinyl butyral, polyurethane, ethylene-vinyl acetate, etc. to form thick ballistic windows. This type of transparent armor is regularly used on combat vehicles and is typically about 100-120 mm (3.9-4.7 in) thick. Such thicknesses, however, can be very heavy and oftentimes prohibitive. For mobile armor applications in vehicles and aircraft in particular, there is a need to reduce the weight of transparent armor without sacrificing ballistic performance.

Higher performance transparent materials such as for example spinels, aluminum oxynitride (AlON), the glass product commonly known as Vycor available from Corning Inc., sapphire, and glass-ceramics are also known, which are substantially harder and perform much better than traditional glass laminates. However, such transparent ceramic materials are not produced in large quantity and large pieces due to their high cost, and as such are considered too expensive for most transparent armor applications.

### SUMMARY OF THE INVENTION

The present invention includes a transparent shield structure comprising: a mosaic tile layer having at least two transparent tiles edge-bonded together in a mosaic arrangement; and a transparent backing plate face-bonded to the mosaic tile layer with a transparent adhesive for reinforcing the mosaic tile layer, whereby the edge-bonded mosaic arrangement of the mosaic tile layer reduces the energy transferred from an impacted tile to an adjacent tile of the mosaic tile layer to localize damage caused by the impact.

The present invention also includes a transparent ballistic armor panel comprising: at least two mosaic tile layers each having at least two transparent bullet-resistant tiles edge-bonded together in a mosaic arrangement with a transparent adhesive having a substantially matching index of refraction, said mosaic tile layers face-bonded together with a transparent adhesive in a stacked arrangement, and the respective edge-bonds of adjacent mosaic tile layers offset from each other so that the mosaic tile layers reinforce each other, whereby the edge-bonded mosaic arrangement of the transparent mosaic tile layer reduces the energy transferred from a bullet-impacted tile to an adjacent tile of the same mosaic tile layer to localize damage caused by the impact.

The present invention also includes a transparent panel comprising: at least two mosaic tile layers each having at least two transparent tiles edge-bonded together in a mosaic arrangement, said mosaic tile layers face-bonded together with a transparent adhesive in a stacked arrangement and the respective edge-bonds of adjacent mosaic tile layers offset from each other so that the mosaic tile layers reinforce each other, whereby the edge-bonded mosaic arrangements of the mosaic tile layers substantially isolate damage sustained by one tile from also damaging adjacent tiles of the same mosaic tile layer.

Generally, the present invention is a transparent armor, shield structure, or panel having as a key structural feature one or more mosaic tile layers each formed by edge-bonding a mosaically arranged set of transparent tiles, preferably with a transparent adhesive having a substantially matching index of refraction. In an exemplary embodiment, the mosaic tile layer is mounted on a transparent backing plate, such as a polycarbonate plate, so as to be reinforced thereby. In particular, the transparent backing plate is face-bonded to a mosaic tile layer with a transparent adhesive. Additional mosaic tile layers may also be face-bonded to the first mosaic tile layer with a transparent adhesive either in addition to the backing plate or in lieu thereof, although a backing plate such as made from a polymeric material, is typically desirable. In an exemplary embodiment, the additional mosaic tile layers are arranged so that the respective edge-bonds of the adjacent mosaic tile layers are offset from each other. This configuration positions the edge-bonds against tile faces of an adjacent mosaic tile layer so that the mosaic tile layers reinforce each other. Furthermore, in another exemplary embodiment, each mosaic tile layer has at least three tiles mosaically arranged so that no more than three of said tiles have a common intersection.

The edge-bonded mosaic arrangement of the mosaic tile layers serves to substantially isolate damage sustained by one tile from also damaging adjacent tiles of the same mosaic tile layer. In particular, the edge-bonded mosaic arrangement reduces the mechanical energy (i.e. shockwave, vibration) transferred from an impacted tile to an adjacent tile of the same mosaic tile layer to localize and limit damage caused by the impact to a small region of the armor panel, ideally to only the impacted tile. In this manner, collateral damage to adjacent tiles is inhibited or at least minimized, and a large percentage of the total armor panel will be left intact for visibility and for subsequent impacts. The mosaic tile arrangement and configuration of the composite panel also allows the use of thicker glass components, which have been shown to provide better ballistic protection than multiple bonded layers of thin glass. The mosaic tile arrangement and configuration of the composite panel also allows the economical use of the more expensive and higher performance transparent materials since the smaller components needed for a mosaic tile design are much less expensive and easier to fabricate and polish than large area windows. For example, higher performance tile materials having a relative hardness greater than the tiles of the other mosaic tile layers may be used for an outer one of the mosaic tile layers (i.e. the impact layer). Smaller thicknesses of these higher performance materials may also be used for the impact tiles (relative to other mosaic tile layers), by reinforcing the impact layer with additional mosaic tile layers made of glass or other less expensive materials. Since the mosaic transparent armor panel of the present invention reduces the region of damage to specific tiles, these tiles can be field patched if the remaining tiles warrant saving. Even larger regions can be repaired in maintenance shops using kits for such repairs.

### BRIEF DESCRIPTION OF THE DRAWINGS

The accompanying drawings, which are incorporated into and form a part of the disclosure, are as follows:

FIG. 1 is a perspective view of nine transparent tiles used to form an exemplary embodiment of a mosaic tile layer of the present invention.

FIG. 2 is a perspective view of the exemplary mosaic tile layer formed by edge-bonding the nine tiles of FIG. 1.

FIG. 3 is an exploded elevational view of an exemplary transparent armor of the present invention.

FIG. 4 is an elevational view of the exemplary transparent armor of FIG. 3 formed by face-bonding the three mosaic tile layers and the transparent backing plate together.

FIG. 5 is a top view of the exemplary transparent armor of FIG. 4, illustrating the offset between the edge-bonds of the outer mosaic tile layer 10, and the edge-bonds of the underlying adjacent mosaic tile layer 20.

FIG. 6 is a top view of another exemplary transparent armor of the present invention, illustrating the offset between tiles of the same mosaic tile layer so that no more than three tiles have a common intersection, in addition to the offset between the edge-bonds of an outer mosaic tile layer, and the edge-bonds of the underlying adjacent mosaic tile layer.

### DETAILED DESCRIPTION

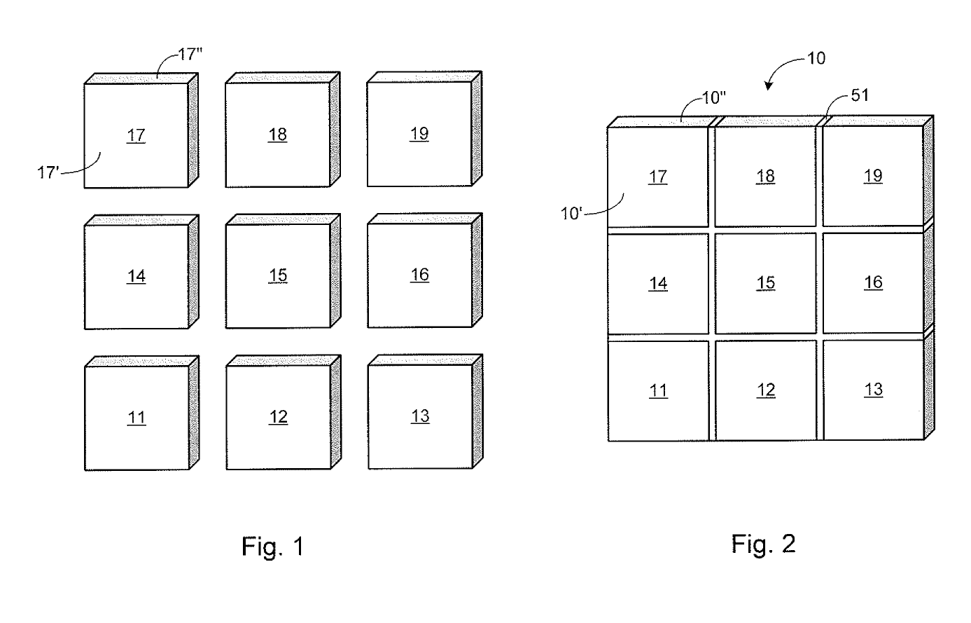

FIGS. 1 and 2 illustrate the edge-bonded mosaic tile arrangement used in constructing the mosaic transparent armor of the present invention. In particular, an example set of nine transparent square tiles (11-19) are shown in FIG. 1, each having a flat panel shape characterized by opposing faces (e.g. 17′ of tile 17) bordered by edges (e.g. 17″ of tile 17), with the breadth of the tiles substantially larger than their thickness. The tiles 11-19 are arranged in a mosaic tile arrangement with the tiles closely positioned along their edges in a substantially coplanar orientation. While rectangular shaped tiles are shown, i.e. having four ninety degree angles, it is appreciated that other tile shapes may be employed, preferably having straight edges so as to facilitate edge-bonding of the tiles, as described below. And the size and thickness of the tiles is design dependent on the type of threat to be defeated and the number of impacts to be stopped. It is known from ballistic testing that a thick glass tile provides enhanced ballistic performance relative to multiple thin layers of equivalent total thickness. The present invention allows the use of the higher performance thick glass while retaining the ability to mitigate collateral damage and inhibit catastrophic failure. It is also appreciated that while transparent tile materials are used for transparent armor applications, opaque materials may be used in the alternative where see-through transparency is not necessary.

And as shown in FIG. 2, the transparent tiles are assembled into a composite mosaic tile layer 10 by edge-bonding the tiles to each other with a transparent adhesive or bond 51. The mosaic tile layer 10 also has opposing faces (e.g. 10′ shown) bordered by edges (e.g. 10″). In an exemplary embodiment, the transparent adhesive has a substantially matching index of refraction as the transparent tiles, e.g. substantially matching with glass. The transparent adhesive can be a polymeric compound, such as urethane P-123-S, but is not limited only to such. The gaps between the tiles are bonded in a manner that sufficient energy from the impact on one tile is not allowed to be transferred into the adjacent tiles where it could cause collateral damage and impair visibility. For example, ⅛″ urethane gaps may be used for 50 caliber fragment simulating projectiles (FSP).

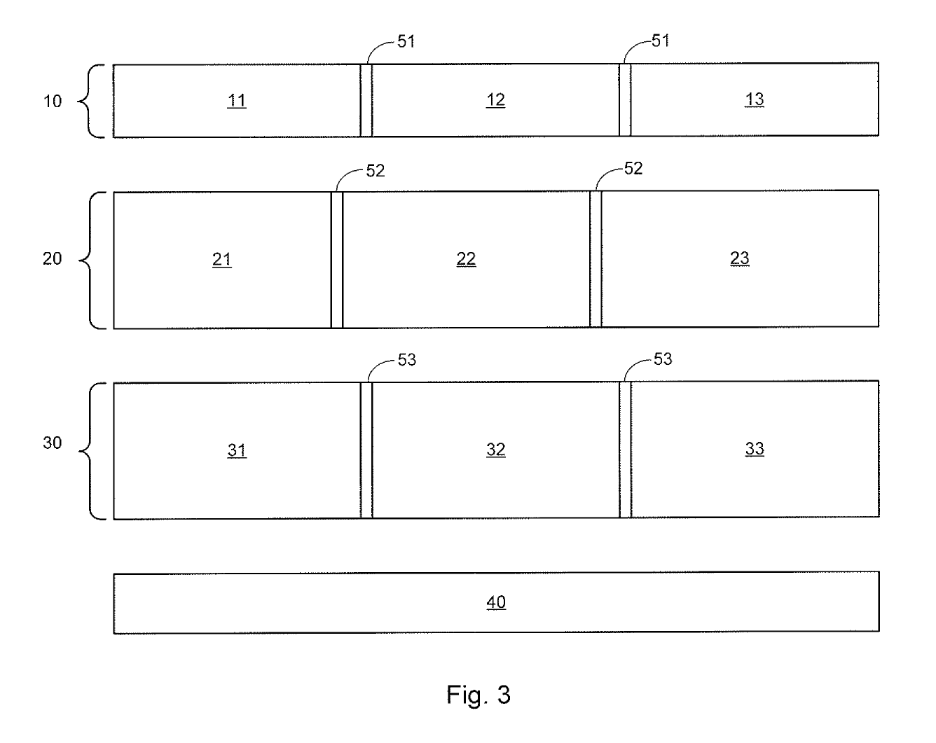

FIG. 3 shows an exploded elevational view of an exemplary transparent armor panel having three mosaic tile layers 10, 20, and 30 and a transparent backing plate 40 in a stacked arrangement. The mosaic tile layer 10 of FIG. 2 is shown here as the outer impact layer having an impact face exposed to projectiles, and is represented by transparent tiles 11-13 which are edge-bonded to each other with transparent adhesive 51. The mosaic tile layer 20 is represented by transparent tiles 21-23 which are edge-bonded to each other with transparent adhesive 52, and the mosaic tile layer 30 is represented by transparent tiles 31-33 which are edge-bonded to each other with transparent adhesive 53. It is appreciated that each of the mosaic tile layers 10, 20, and 30 include additional transparent tiles not shown in FIG. 3 (e.g. tiles 14-19 for layer 10).

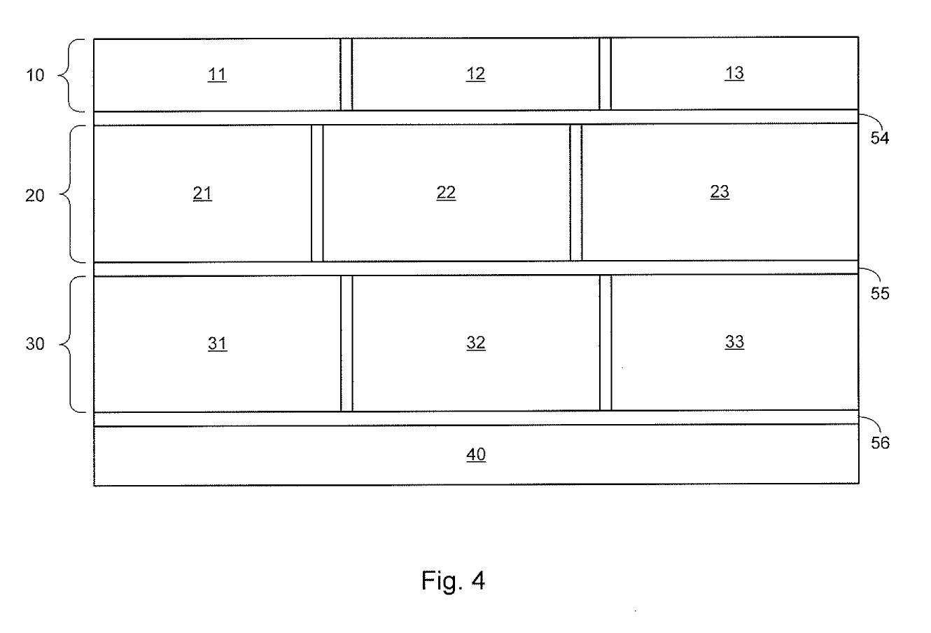

And FIG. 4 shows the three mosaic tile layers 10, 20, and 30 and the transparent backing plate 40 of FIG. 3 face-bonded, i.e. face to face, to each other in a stack arrangement with a transparent adhesive, e.g. a polymeric compound, to form the transparent armor panel. In particular, mosaic tile layers 10 and 20 are face-bonded with transparent adhesive 54, layers 20 and 30 are face-bonded with transparent adhesive 55, and layer 30 and backing plate 40 are face-bonded with transparent adhesive 56. In this manner, the mosaic composite panel is itself transparent for see-thru capability. Transparent adhesives 54, 55, and 56 may be of the same type or different types. The backing plate is shown having a size that is substantially equivalent to the mosaic tile layers to provide structural reinforcement, and is bonded to the mosaic tile layers with a transparent adhesive 56. The transparent adhesive preferably has a substantially matching index of refraction as the other face-bonds 54, 55, as well as the edge bonds between tiles. The backing plate serves as a backup to the mosaic tile layers, and may also be constructed from two, three, or more layers of transparent materials, by bonding them together with adhesives to provide a transparent backing plate with improved ballistic performance. The backing plate is preferably made of a polymeric material such as a polycarbonate to shatterproof the panel, but typically provides little protection against bullet penetration without harder layers in front of the backing plate. It is the much harder material, e.g. glass and ceramics, which prevents penetration by bullets.

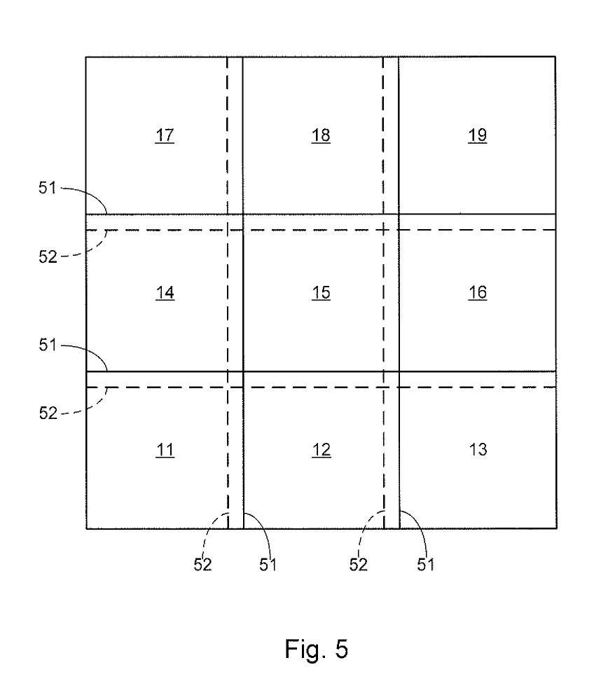

FIG. 5 shows a top view of the armor panel of FIG. 4, illustrating the offset between the respective edge-bonds of representative adjacent mosaic tile layers 10 and 20, as a representative example of the offsets between any pair of adjacent mosaic tile layers. In particular the edge-bonds 51 of the top impact layer 10 consisting of tiles 11-19, are offset from the edge-bonds 52 of the mosaic tile layer 20 immediately below. In this manner, the edge-bonds of each mosaic tile layer is adjacent and backed by a face of the adjacent mosaic tile layer, to reinforce the edge-bond and enhance the structural rigidity of the armor panel.

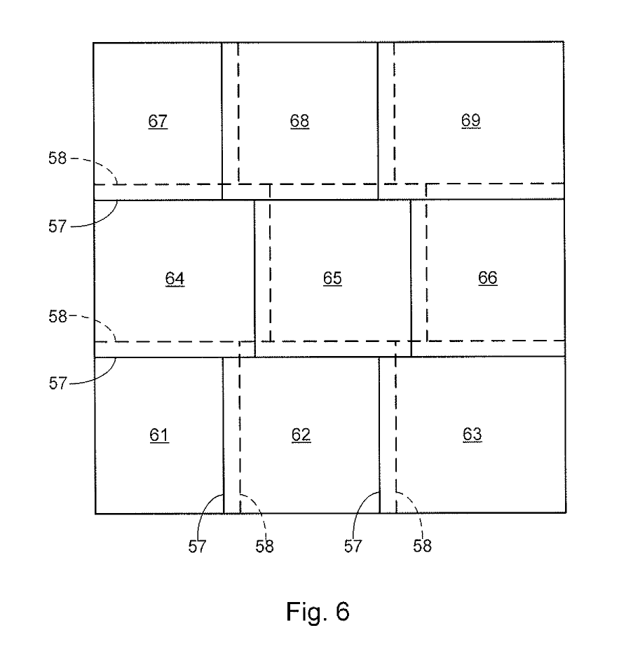

FIG. 6 shows a top view of another exemplary embodiment of the armor panel, illustrating offset of tiles in different rows within the same mosaic tile layer. In particular, the edge-bonds 57 between tiles 61-69 of the impact layer are shown having no more than three tiles with a common intersection, which can be an edge, point, surface, line, etc. This offset arrangement of tiles in a mosaic layer also enhances structural rigidity which maintains the structural integrity during impact. FIG. 6 shows both the offset of tiles within a mosaic tile layer, as well as the offset of edge-bonds between adjacent mosaic tile layers, i.e. the offset between edge-bonds 57 of the impact layer, from edge-bonds 58 in the adjacent mosaic tile layer.

Additional enhancement of the ballistic performance of the armor panel can be achieved, for example, by using a thinner, harder material for the impact layer, such as those described in the Background, instead of common glass tiles. Since the tile size is small in comparison to the total window area, the cost for these harder materials can be much more reasonable due to lower fabrication and polishing costs for smaller components. Furthermore, these harder materials can be backed up with standard glass tiles in adjacent mosaic tile layers to keep the costs down. Preferably, the relative hardness of the tiles of the impact layer is greater than the other tiles, and is thinner than the other tiles.

It is appreciated that the transparent panel, shield, and armor of the present invention may be designed with various dimensions, scale, material selection, and other design parameters. For illustrative purposes only, an example armor panel may have a construction similar to that shown in FIG. 1-5, with the following exemplary dimensions. Tiles 11-13 and 31-33 shown in FIG. 4 are square tiles, e.g. with 3-5″ sides, with the edge-bonds therebetween and the face-bonds between mosaic tile layers having a suitably thin thickness, e.g. 0.125″ thickness edge-bonds and 0.015″ thickness face-bonds. The mosaic tile layers 20 and 30 are constructed from thick glass e.g. 0.75″ thickness, and the impact layer 10 is constructed from a harder material than glass with a thickness less than 0.75″ thickness, e.g. 0.2″ thickness. Generally the thickness of the harder material may be set to be approximately ⅔ the diameter of the threat to be defeated, but is ultimately dependent on the specific armor application. And the backup glass tiles of the mosaic tile layers is preferably as thick as possible within prescribed design parameters considering weight/cost for a specific application. At least one layer of glass is preferably to be bonded between the harder material and the transparent backing plate. And the transparent backing plate made of polycarbonate spans at least the entire length of the mosaic tile layers, e.g. 14″×14″ with 0.25″ thickness.

While particular operational sequences, materials, temperatures, parameters, and particular embodiments have been described and or illustrated, such are not intended to be limiting. Modifications and changes may become apparent to those skilled in the art, and it is intended that the invention be limited only by the scope of the claims.

We claim:

1. A transparent shield structure comprising:
a mosaic tile layer having at least two transparent tiles edge-bonded together in a mosaic arrangement; and
a transparent backing plate face-bonded to the mosaic tile layer with a transparent adhesive for reinforcing the mosaic tile layer,
whereby the edge-bonded mosaic arrangement of the mosaic tile layer reduces the energy transferred from an impacted tile to an adjacent tile of the mosaic tile layer to localize damage caused by the impact.

2. The transparent shield structure of claim 1,
wherein the tiles of the mosaic tile layer are edge-bonded together with a transparent adhesive having a substantially matching index of refraction.

3. The transparent shield structure of claim 1,
wherein the mosaic tile layer has at least three tiles mosaically arranged so that no more than three of said tiles have a common intersection.

4. The transparent shield structure of claim 1,
further comprising at least one additional mosaic tile layer(s) having at least two tiles edge-bonded together in a mosaic arrangement, with said mosaic tile layers face-bonded together with a transparent adhesive in a stacked arrangement.

5. The transparent shield structure of claim 4,
wherein the respective edge-bonds of adjacent mosaic tile layers are offset from each other so that the mosaic tile layers reinforce each other.

6. The transparent shield structure of claim 4,
wherein the tiles of an outer one of the mosaic tile layers have a relative hardness greater than the tiles of the other mosaic tile layer(s).

7. The transparent shield structure of claim 6,
wherein the tiles of the outer mosaic tile layer have a relative thickness less than the tiles of the other mosaic tile layer(s).

8. A transparent ballistic armor panel comprising:
at least two mosaic tile layers each having at least two transparent projectile-resistant tiles edge-bonded together in a mosaic arrangement with a transparent adhesive having a substantially matching index of refraction, said mosaic tile layers face-bonded together with a transparent adhesive in a stacked arrangement, and the respective edge-bonds of adjacent mosaic tile layers offset from each other so that the mosaic tile layers reinforce each other,
whereby the edge-bonded mosaic arrangement of the transparent mosaic tile layer reduces the energy transferred from a projectile-impacted tile to an adjacent tile of the same mosaic tile layer to localize damage caused by the impact.

9. The transparent ballistic armor panel of claim 8,
further comprising a transparent polymeric plate face-bonded to one of the mosaic tile layers with a transparent adhesive for reinforcing the mosaic tile layers.

10. The transparent ballistic armor panel of claim 9,
wherein the transparent polymeric plate comprises at least two polymeric layers face-bonded together with a transparent adhesive.

11. The transparent ballistic armor panel of claim 8,
wherein each mosaic tile layer has at least three tiles mosaically arranged so that no more than three of said tiles have a common intersection.

12. The transparent ballistic armor panel of claim 8,
wherein the tiles of an outer one of the mosaic tile layers have a relative hardness greater than the tiles of the other mosaic tile layer(s).

13. The transparent ballistic armor panel of claim 12,
wherein the tiles of the outer one of the mosaic tile layers have a relative thickness less than the tiles of the other mosaic tile layer(s).

14. A transparent panel comprising:
at least two mosaic tile layers each having at least two transparent tiles edge-bonded together in a mosaic arrangement, said mosaic tile layers face-bonded together with a transparent adhesive in a stacked arrangement, and the respective edge-bonds of adjacent mosaic tile layers offset from each other so that the mosaic tile layers reinforce each other,
whereby the edge-bonded mosaic arrangements of the mosaic tile layers substantially isolate damage sustained by one tile from also damaging adjacent tiles of the same mosaic tile layer.

15. The transparent panel of claim 14,
further comprising a transparent backing plate face-bonded to one of the mosaic tile layers with a transparent adhesive for reinforcing the mosaic tile layers,

16. The transparent panel of claim 15,
wherein the transparent backing plate comprises at least two polymeric layers face-bonded together with a transparent adhesive.

17. The transparent panel of claim 14,
wherein for each mosaic tile layer, the tiles are edge-bonded together with a transparent adhesive having a substantially matching index of refraction.

18. The transparent panel of claim 14,
wherein each mosaic tile layer has at least three tiles mosaically arranged so that no more than three of said tiles have a common intersection.

19. The transparent panel of claim 14,
wherein the tiles of an outer one of the mosaic tile layers have a relative hardness greater than the tiles of the other mosaic tile layer(s).

20. The transparent panel of claim 19,
wherein the tiles of the outer mosaic tile layer have a relative thickness less than the tiles of the other mosaic tile layer(s).
